(19) United States
(12) Patent Application Publication
(10) Pub. No.: US 2013/0196161 A1
(43) Pub. Date: Aug. 1, 2013

(54) LAMINATES USEFUL FOR ELECTRICAL INSULATION

(71) Applicants: BYOUNG SAM KANG, Midlothian, VA (US); MIKHAIL R. LEVIT, Glen Allen, VA (US); JEAN CLAUDE DUART, St. Julien En Genevois (FR); SERGE REBOUILLAT, Echenevex (FR)

(72) Inventors: BYOUNG SAM KANG, Midlothian, VA (US); MIKHAIL R. LEVIT, Glen Allen, VA (US); JEAN CLAUDE DUART, St. Julien En Genevois (FR); SERGE REBOUILLAT, Echenevex (FR)

(73) Assignee: EI DU PONT DE NEMOURS AND COMPANY, Wilmington, DE (US)

(21) Appl. No.: 13/561,135

(22) Filed: Jul. 30, 2012

Related U.S. Application Data
(60) Provisional application No. 61/514,535, filed on Aug. 3, 2011.

(51) Int. Cl. H01B 3/00

(52) U.S. Cl. CPC H01B 3/006
USPC 428/414; 428/413; 428/423.5; 428/447; 428/454

(57) ABSTRACT

A laminate useful for electrical insulation having: (a) at least one layer of a mica-aramid paper comprising 55 to 95 weight percent mica and 5 to 45 weight percent aramid and (b) at least one layer of a polymeric electrical insulating film bonded to the mica-aramid paper with an adhesive.

### BACKGROUND OF THE INVENTION

1. Field of the Invention

The present invention relates to laminates useful for electrical insulation.

2. Description of the Related Art

Low and medium voltage motors and generators usually use multilayered insulating materials. The most common laminate structures have a symmetrical, three-layer construction with aramid paper or a polyester mat on the outside and polyester film on the inside. Most standard products are called NMN (N stands for NOMEX® T464 or T416 and M could be Mylar® film) or DMD (D could be Dacron® and M could be Mylar®). These materials are used in all kinds of electrical components but more particularly in rotating equipments like motors or generators with low voltages (nominal voltage below 1000 V). However, none of these materials are considered to be highly resistant to higher temperature environments or partial corona discharge which occurs during peak voltage stress, which is specifically high in rotating machines with inverters or converters.

It is therefore desirable to prepare a laminate useful for electrical insulation with improved thermal stability and improved corona discharge resistance while retaining acceptable mechanical strength.

### SUMMARY OF THE INVENTION

The present invention is directed to a laminate useful for electrical insulation comprising: (a) at least one layer of a mica-aramid paper comprising 55 to 95 weight percent mica and 5 to 45 weight percent aramid and (b) at least one layer of a polymeric electrical insulating film bonded to the mica-aramid paper with an adhesive.

A further embodiment of the present invention includes the above laminate wherein the mica-aramid paper has a two-ply structure with a mica-rich ply and a mica-poor ply wherein the mica-rich ply has a higher mica content than the mica-poor ply and the mica-rich ply comprises 80 to 95 weight percent mica.

The laminate set forth above is useful as electrical insulation in an electrical device such as a motor or generator.

### DETAILED DESCRIPTION OF THE INVENTION

The present invention provides a laminate useful for electrical insulation with improved thermal stability and improved corona discharge resistance while retaining acceptable mechanical strength.

The present invention is best described through the use of the following terms.

The term “mica”, as used herein, means a type of silicate mineral. A preferred type of mica for electrical insulation is muscovite.

The term “aramid”, as used herein, means aromatic polyamide, wherein at least 85% of the amide (—CONH—) linkages are attached directly to two aromatic rings. Optionally, additives can be used with the aramid and may be dispersed throughout the polymer structure. It has been found that up to as much as about 10 percent by weight of other polymeric material can be blended with the aramid. It has also been found that copolymers can be used having as much as 10 percent of other diamines substituted for the diamine of the aramid or as much as 10 percent of other diacid chlorides substituted for the diacid chloride of the aramid. Meta-aramids are those aramids where the amide linkages are in the meta position relative to each other. A preferred meta-aramid is poly(metaphenylene isophthalamide).

The term “fibrids”, as used herein, means nongranular, fibrous or film-like particles with at least one of their three dimensions being of minor magnitude relative to the largest dimension. These particles can be prepared by precipitation of a solution of polymeric material using a non-solvent under high shear. The fibrids have a largest dimension length in a range from 0.2 mm to 1 mm with a length-to-width aspect ratio of 2:1 to 10:1. The thickness dimension is on the order of a fraction of a micrometer, for example, 0.1 micrometer to about 1.0 micrometer. The fibrids, before being dried, can be used wet and can be deposited as a paper forming component.

The term “floc”, as used herein, means fibers that are cut to a short length and which are customarily used in the preparation of wet-laid sheets. Typically, floc has a length of from 3 to 20 millimeters. A preferred length is from 3 to 7 millimeters. Floc is normally produced by cutting continuous fibers into the required lengths using well-known methods in the art.

In the event a combination of floc and fibrid is employed for the aramid, a preferred weight ratio of floc to fibrid is in a range from 0.5 to 4.0 and more preferably 0.8 to 2.0.

The present invention is directed to a laminate useful for electrical insulation comprising: (a) at least one layer of a mica-aramid paper comprising 55 to 95 weight percent mica and 5 to 45 weight percent aramid and (b) at least one layer of a polymeric electrical insulating film bonded to the mica-aramid paper with an adhesive. More preferably, the mica-aramid paper comprises 65 to 95 weight percent mica and 5 to 35 weight percent aramid. Most preferably, the mica-aramid paper comprises 75 to 90 weight percent mica and 10 to 25 weight percent aramid.

A further embodiment of the present invention includes the above laminate wherein the mica-aramid paper has a two-ply structure with a mica-rich ply and a mica-poor ply wherein the mica-rich ply has a higher mica content than the mica-poor ply and the mica-rich ply comprises 80 to 95 weight percent mica. More preferably, the mica-rich ply comprises 80 to 90 weight percent mica.

The aramid can comprise 50 to 100 weight percent fibrid and 0 to 50 weight percent floc. Also, the aramid can be poly(metaphenylene isophthalamide).

The polymeric electrical insulating film can be selected from, but is not limited to, polyester film, polyphenylene sulfide, and polyimide film.

The adhesive can be selected from, but is not limited to, polyurethane, epoxy, polyimide, phenolic, melamine, alkyd, polyester, polyesterimide, benzoxazine, silicone and combinations thereof. Also, the adhesive layer can be composed of a non-inherently adhesive material. The non-inherently adhesive material can be made of a sacrificial layer which will melt or phase change during the lamination process such as to produce a binding adhesive interface via partial migration through both adjacent layers and thereby creating an anchoring adhesive zone. Examples of non-inherently adhesive materials are polyethylene, polypropylene, hot melts and combinations thereof.

In certain end uses, a resin can be added to the laminate of the present invention in the amount of 1 to 50 weight percent resin based on the total of the mica, aramid and resin. The resin can be selected from but is not limited to polyurethane, epoxy, polyimide, phenolic, melamine, alkyd, polyester, polyesterimide, benzoxazine, silicone and combinations thereof.

The laminate set forth above is useful as electrical insulation in an electrical device such as a motor or generator.

### Test Methods

The following test methods were used in the Examples provided below.

Thickness was measured according to ASTM D 646-96 and reported in mm.

Basis Weight was measured according to ASTM D 645 and ASTM D 645-M-96 and reported in g/m².

Tensile Strength was measured according to ASTM D 828-93 with 2.54 cm wide test specimens and a gage length of 18 cm and reported in MPa.

Initial Tear Resistance was measured according to ASTM D 1004 and reported in Newton.

Dielectric Strength was measured according to ASTM D 149-97A and reported in kV/cm.

Volume Resistivity was measured according to ASTM D 257 and reported in ohm-cm at 500 V.

Thermal Conductivity was measured according to ASTM E 1530 and reported in W/mK.

Voltage Endurance was measured according to ASTM D 2275-01 and reported in hours at 300 V/cm, 360 Hz.

### EXAMPLES

Hereinafter the present invention will be described in more detail in the following examples.

### Example 1

A laminate according to the invention was prepared having a structure consisting of a two-ply mica-aramid paper/polymeric electrical insulating film/two-ply mica-aramid paper.

The two-ply mica-aramid paper was made from a mica-rich ply and a mica poor ply. The mica-rich ply consisted of 90 weight percent mica flake (muscovite type available from the Electrical Samica Flake Co., Rutland, Vt.) and 10 weight percent meta-aramid fibrids (made from poly(metaphenylene isophthalamide) in a manner generally described in U.S. Pat. No. 3,756,908). The mica-poor ply consisted of 45 weight percent mica flake, 40 weight percent meta-aramid fibrids and 15 weight percent meta-aramid floc (made from poly(metaphenylene isophthalamide) 0.22 tex linear density and 0.64 cm length Nomex® available from E.I du Pont de Nemours and Co., Wilmington, Del. (DuPont). Aqueous dispersions of the mica-poor and mica-rich components were pumped accordingly through primary and secondary headboxes of a Fourdrinier-type papermaking machine. A layered wet-laid paper was formed with a mica-rich ply on the top and a mica-poor ply on the bottom. The basis weight of the top ply was about 85 g/m² and basis weight of the bottom ply was about 50 g/m². The layered wet-laid paper was laminated in a hot nip of a calender at a nip pressure of about 3000 N/cm and a roll temperature of about 220° C. The polymeric electrical insulating film used was a 5 mil polyester film (available from Garware Polyester Limited, Mumbai, India). The polyester film was sandwiched between two, two-ply mica-aramid papers with the mica-rich ply facing the film and laminated together using an epoxy adhesive to produce a laminate according to the invention.

The laminate composition is summarized in Table 1 and the physical properties are shown in Table 2.

### Example 2

Example 2 was made in a similar manner to Example 1, except the two-ply mica-aramid papers were replaced with single-ply mica-aramid papers.

The single-ply paper consisted of 70 weight percent mica flake, 15 weight percent meta-aramid fibrids and 15 weight percent meta-aramid floc.

The laminate composition is summarized in Table 1 and the physical properties are shown in Table 2.

### Comparative Examples A and B

Comparative Examples A and B were made in a similar manner to Example 2 except with different single-ply papers.

In Comparative Example A, the single ply paper was Nomex® T418 containing 50 weight percent mica. In Comparative Example B, the single ply paper was Nomex® T416 containing no mica.

The laminate compositions are summarized in Table 1 and the physical properties are shown in Table 2.

Table 2 shows a significant increase in voltage endurance and decrease in volume resistivity for Examples 1 and 2 over the Comparative Examples. This improvement is a result of the increased mica content and two-ply structure in the mica-aramid paper of the present invention.

TABLE 1
COMPOSITION OF LAMINATE STRUCTURES

| | | Outside | | Inside |
|---|---|---|---|---|
| | | Layer | | Layer |
| Exam- | | Mica | Aramid | Polyester |
| ple | Laminate Structure | (wt %) | (wt %) | (wt %) |
| 1 | mica-aramid (two-ply)/polyester | 36.8 | 16.3 | 46.9 |
| | film/mica-aramid (two-ply) | | | |
| 2 | mica-aramid (single-ply)/ | 36.3 | 15.2 | 48.5 |
| | polyester film/ | | | |
| | mica-aramid (single-ply) | | | |
| A | T418/polyester film/T418 | 23.7 | 23.9 | 52.4 |
| B | T416/polyester film/T416 | 0 | 37.4 | 62.6 |

TABLE 2
PHYSICAL PROPERTIES OF LAMINATE STRUCTURES

| | | Example and Comparative Examples | | | |
|---|---|---|---|---|---|
| Properties | | 1 | 2 | A | B |
| Thickness (mm) | | 0.29 | 0.30 | 0.30 | 0.32 |
| Basis Weight (g/m²) | | 412 | 407 | 375 | 337 |
| Tensile | Unfolded | 0.76 | 0.77 | 0.79 | 1.17 |
| Strength | Folded | 0.74 | 0.78 | 0.63 | 1.04 |
| (MPa) | | | | | |
| Elongation (%) | | 5.2 | 4.3 | 5.1 | 28 |
| Initial Tear | MD | 56 | 57 | 56 | 60 |
| Resistance | CD | 53 | 57 | 62 | 76 |
| (N) | | | | | |
| Dielectric Strength | | 8,490 | 8,460 | 8,980 | 7,990 |
| (kV/cm) | | | | | |
| Volume Resistivity | | 1.33 | 2.75 | 5.97 | 17.0 |
| at 500 V | | | | | |
| (ohm-cm × 10¹⁵) | | | | | |
| Thermal Conductivity | | 0.097 | 0.086 | 0.087 | 0.094 |
| (W/mK) | | | | | |
| Voltage | 23° C. | 1,393 | 516 | 488 | 19 |
| Endurance, | 180° C. | 72 | 42 | 11 | 1 |
| Tested hours | | | | | |
| at 300 V/cm, | | | | | |
| 360 Hz (h) | | | | | |

MD: Machine Direction
CD: Cross Machine Direction

What is claimed is:

1. A laminate useful for electrical insulation comprising:
(a) at least one layer of a mica-aramid paper comprising 55 to 95 weight percent mica and 5 to 45 weight percent aramid and
(b) at least one layer of a polymeric electrical insulating film bonded to the mica-aramid paper with an adhesive.

2. The laminate of claim 1, wherein the mica-aramid paper has a two-ply structure with a mica-rich ply and a mica-poor ply wherein the mica-rich ply has a higher mica content than the mica-poor ply and the mica-rich ply comprises 80 to 95 weight percent mica.

3. The laminate of claim 1 or 2, wherein the aramid comprises 50 to 100 weight percent fibrid and 0 to 50 weight percent floc.

4. The laminate of claim 1 or 2, wherein the aramid is poly(metaphenylene isophthalamide).

5. The laminate of claim 1 or 2, wherein the polymeric electrical insulating film is selected from the group consisting of polyester film, polyphenylene sulfide film, and polyimide film.

6. The laminate of claim 1 or 2, wherein the adhesive is selected from the group consisting of polyurethane, epoxy, polyimide, phenolic, melamine, alkyd, polyester, polyesterimide, benzoxazine, silicone and combinations thereof.

7. The laminate of claim 1 or 2, wherein the mica-aramid paper further comprises 1 to 50 weight percent resin based on the total weight of the mica, aramid and resin.

8. The laminate of claim 7, wherein the resin is selected from the group consisting of polyurethane, epoxy, polyimide, phenolic, melamine, alkyd, polyester, polyesterimide, benzoxazine, silicone and combinations thereof.

9. An electrical device comprising the laminate of claim 1 or 2.

10. The electrical device of claim 9, which is a motor.

11. The electrical device of claim 9, which is a generator.
